(19) United States
(12) Patent Application Publication
(10) Pub. No.: US 2026/0366954 A1
(43) Pub. Date: Nov. 19, 2026

(54) ROBOTIC SHOCK TESTING SYSTEM AND METHOD OF USE

(71) Applicant: Raytheon Company, Arlington, VA (US)

(72) Inventor: Robin Mihekun Miller, Tucson, AZ (US)

(21) Appl. No.: 19/210,776

(22) Filed: May 16, 2025

(51) Int. Cl. G01M 7/08; B25J 9/16; B25J 13/08; B25J 19/00

(52) U.S. Cl. CPC G01M 7/08; B25J 9/1633; B25J 9/1679; B25J 13/085; B25J 19/0091

(57) ABSTRACT

A shock testing system can include a robotic force application mechanism including a shock affecting component positioned along a distal portion of the robotic force application mechanism. A testing unit can be positioned proximate to the shock affecting component. The shock affecting component can be designed to transfer a force to the testing unit. The shock testing system can include control circuitry in communication with the shock affecting component. The control circuitry can be configured to supply instructions associated with the force to be transferred to the testing unit to the robotic force application mechanism. The shock affecting component can transfer the force to the testing unit and undergo a plastic deformation.

### BACKGROUND

Aeronautic structures can be subjected to various forms of shock loading. Shock loading can include sudden, high-intensity forces or pressure changes occurring over short timescales. These shocks can originate from external sources or internal events. The shock experienced can occur as a shock wave that can travel through an aircraft’s structure. The magnitude and impact of such shocks can be influenced by the material properties, structural design, and damping characteristics of the aircraft. In high-speed and supersonic flight regimes, aeronautic structures can encounter aerodynamic shock waves. The aerodynamic shock waves can occur around areas where airflow transitions from subsonic to supersonic speeds. Shock can be experienced during moving of a structure, such as during shipment and associated activities.

Shock on a structure can be measured using a combination of sensors, data acquisition systems, and analytical methods designed to capture the transient forces and responses that occur during a shock event. Shock can be measured using devices such as accelerometers, strain gauges, force transducers, or the like.

### SUMMARY

A robotic system can be implemented to simulate shock experienced during certain events such as high-speed events, shipment of products (e.g., structures), or associated handling activities. A robotic shock application device can be used to interact with a testing unit. The testing unit can be formed to simulate a structure that can exposed to aerospace environments or situations. The testing unit can be used to simulate structures that can be transported. The robotic shock application device can apply a force to the testing unit that can simulate the shock experienced by the structure. The robotic shock application device can be designed to apply a shock profile, including acceleration, velocity and duration factors, to the testing unit.

Robotic shock testing can be performed by applying a substantially consistent shock profile, or force, to the testing unit. The substantially consistent shock profile can cause the unit under test (e.g., testing unit) to undergo plastic deformation.

The concepts herein can combine a robotic application of desired velocities and forces with specially designed crushable or fracturing media that can achieve consistent, extended-duration shock profiles by utilizing plastic deformation and fracture energy.

### BRIEF DESCRIPTION OF THE DRAWINGS

FIG. 1 illustrates an example of shock application device according to at least one example of the present disclosure.

FIG. 2 illustrates an example of a shock testing system according at least one example of the present disclosure.

FIG. 3 illustrates an example of a shock effecting component undergoing plastic deformation according to at least one example of the present disclosure.

FIG. 4 illustrates an example method of robotic shock testing according to at least one example of the present disclosure.

### DETAILED DESCRIPTION

Testing systems can utilize equipment to replicate real-world conditions that structures can encounter during operation. Multiple testing devices can be combined or used to achieve more comprehensive simulation of environmental conditions. Testing procedures can require reconfiguration and calibration between test iterations to maintain accuracy and consistency.

Structures can benefit from testing to understand the effects of forces on the structure. Such effects can include forces or movements that the structure can experience either at rest or when in motion. Forces or movements can include shocks or vibrations or a combination that can affect the integrity of the structure. A shock can include a sudden application of a force or an abrupt change in motion that can affect the integrity of a structure. Vibration can include an oscillatory or repetitive motion of an object about its equilibrium point.

Shock and vibration can occur as pressure waves that are transferred through a medium, such as through a fluid or a solid. Shock and vibration can include pressure waves that can be experienced by a structure. The structure can experience shock or vibration through the entirety of a structure from an initial point of the structure that is closest to the origin of the shock or vibration to portions of the structure remote from the origin of the shock or vibration. Different portions of the structure can have a dissimilar experience to the shock or vibration. Different portions of the structure can have a similar or equivalent experience to the shock or vibration.

A shock wave can generate high-frequency stress waves that can induce localized deformation, delamination in composite materials, or even fracture in metallic components. Aerodynamic shock waves can cause abrupt changes in pressure and temperature along one or more surfaces of a structure. Imposing mechanical loads can challenge structural integrity. For instance, shock-induced boundary layer separation can lead to buffeting or unsteady aerodynamic forces and can generate fluctuating stress fields throughout the airframe. The design of supersonic aircraft can incorporate features such as shock absorbers, reinforced leading edges, and heat-resistant materials to mitigate these affects. Accurate prediction and control of shock behavior can be beneficial for both safety and performance in structures.

Vibration or shock can be studied as they relate to specific structures. For example, these factors can be accounted for during a design phase of a structure. Advanced modeling and testing can be implemented to study or predict the structural response under loads, forces, or the like. Testing methods can include studying or understanding a shock as a sudden application of force or an abrupt change in motion that can damage a structure, device, or system. A shock can include a non-periodic disturbance. A shock can be characterized by a sudden and severe disturbance. In some examples, testing methods can include understanding a shock that can lead to various affects like fractures, instability, decreased reliability, and shortened service life of a structure.

Shock testing systems can employ specialized equipment to replicate environmental conditions experienced by structures during operational use. Some shock testing systems can include multiple devices to apply forces to simulate shock. One shock testing system can include a timed ball drop mechanism for testing for shock profiles. A timed ball drop mechanism in a testing procedure can include a device or system designed to release a ball or a series of balls at a precise, set time or interval. Time ball drop mechanisms can be included in experiments or tests where accurate timing and consistent release conditions are important to understanding the effects of a force applied to a structure.

Current testing methods can include testing systems that can require extensive setup time between tests or even steps of a test. Testing systems implemented to understand shock can include complicated setups that can require specialized equipment. The testing equipment can require repetitive setups after each iteration of the test. Some testing equipment can take days, weeks or longer to tune the testing system to meet specific shock profiles.

The testing systems and procedures discussed below can include a robotic system that can be configured (e.g., built, arranged, assembled or the like) to deliver a force according to custom impact profiles. The custom impact profile can include achieving desired shocks, or approximating desired shocks. The desired shocks can include a shock, or an approximate shock, experienced by a structure. The shock can include a shock experienced by a structure during use. In one example, the structure can simulate an aerospace structure, and the shock can include a shock experienced by the aerospace structure during flight. Shock can be experienced during, for example, stage 3 ignition, launch, or payload ejection. In another example, the shock can include a force experienced during transportation of a structure.

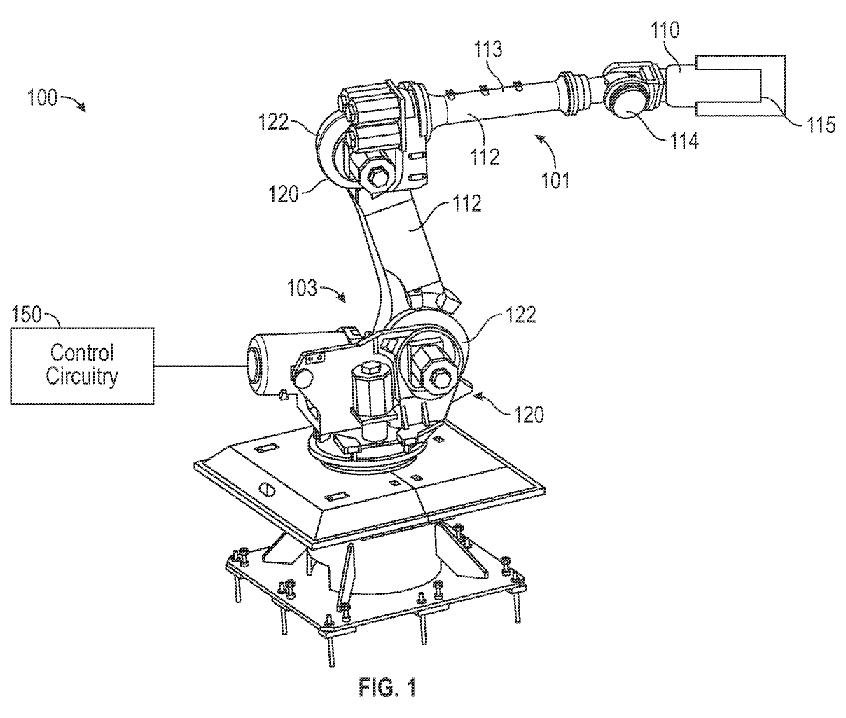

FIG. 1 illustrates an example of a shock application device 100. The shock application device 100 can be designed and formed to include components that can move according to the use of the shock application device 100. Movement of the components can include movement controlled by control circuitry including robotics. For example, control circuitry 150 can be programmed to deliver movement instructions to the shock application device 100. The components of the shock application device 100 can move, articulate, rotate, pivot, translate or a combination of movements according to the design and purpose of the shock application device 100. The control circuitry 150 can be internal to the shock application device 100 or external to the shock application device 100. Optionally, the control circuitry 150 can include components both internal and external to the shock application device 100. For example, the control circuitry can include wired solutions, software based solutions or any combination thereof.

The shock application device 100 can include a robotic force application mechanism 101. The robotic force application mechanism 101 can include components that form a robotic device. The robotic device can include one or more linkages 112 and one or more joints 122. The one or more joints 122 can couple together at least two of the one or more linkages 112. The combination of the one or more linkages 112 and the one or more joints 122 can reposition portions of the robotic force application mechanism 101 along one or more axes, such as x, y, and z axes.

The one or more linkages 112 can include the force application arm 113. The force application arm 113 can extend away from a central body 103 of the shock application device 100. The central body 103 can include a supportive structure of the shock application device 100. The central body 103 can include foundational components of the shock application device 100. At least one of the one or more linkages 112 can be coupled with portions of the central body 103.

The force application arm 113 can be designed to move (e.g., articulate, rotate, pivot, translate or the like) relative to the central body 103. The force application arm 113 can extend from one or more joints 122 coupling the force application arm 113 with the central body 103. The one or more joints 122 can directly couple the force application arm 113 with the central body 103. The one or more joints 122 can be an intermediary coupling between the central body 103 and the force application arm 113. At least one of the one or more joints 122 can be designed to facilitate repositioning the force application arm 113 relative to the central body 103. The one or more joints 122 can be formed to movably couple the force application arm 113 with the central body 103. For example, the force application arm 113 can pivot about the one or more joints 122.

The force application arm 113 can be repositioned or move relative to the central body 103 with a movement mechanism 120. The movement mechanism 120 can be housed, retained, or coupled with a proximal joint portion 123 of the force application arm 113. The proximal joint portion 123 can be a joint of the one or more joints 122 that can be positioned at a proximal portion of the force application arm 113.

The movement mechanism 120 can include control circuitry 150 that can receive instructions related to the position or actions for directing movement of the force application arm 113 or components coupled with the force application arm 113. The movement mechanism 120 can be activated to transition the force application arm 113 along at least one of three axes, such as x, y, and z.

The robotic force application mechanism 101 can include a shock affecting component 110 positioned proximate to a distal portion of a force application arm 113. The distal portion of the force application arm 113 can include the portion of the arm that can be positioned closest to a unit under test (e.g., testing unit). The shock affecting component 110 can be coupled with a distal portion of the force application arm 113. The shock affecting component 110 can be directly or indirectly coupled with the force application arm 113. The shock affecting component 110 can be movably coupled with a distal portion of the shock affecting component 110. The shock affecting component 110 can be coupled with the force application arm 113 to move, such as to articulate, rotate, pivot, translate or the like relative to the force application arm 113. The shock affecting component 110 can move along one or more axes, such as x, y, and z. The shock affecting component 110 can be coupled with the distal portion of the force application arm 113 to move independently of the force application arm 113 along one or more axes. In an example, the shock affecting component 110 can move between or a long two or more of the axes, such as in a height, length or depth.

The shock affecting component 110 can include a force application face 115. The force application face 115 can be designed to apply a force, such as a shock to a structure. The one or more actuators 114 can enable the shock affecting component 110 to move in such a way as to transfer a force from the robotic force application mechanism 101 toward a structure. The force application face 115 can include a planar surface, rounded surface, or undulating surface at a distal portion of the shock affecting component 110. The force application face 115 can be designed to engage (e.g., contact, momentarily contact, touch, or the like) with a structure. The force application face 115 via the shock affecting component 110 can apply, for example, a force to the structure, such as a testing sample (e.g., unit under test). In an example, the force application face 115 of the shock affecting component 110 can briefly (e.g., less than a second, less than 50 milliseconds, less than 20 milliseconds or the like) engage with the structure, as a unit under test or a testing sample, to apply a force to the structure.

The shock application device 100 can include, such as to be coupled with, control circuitry 150. Control circuitry 150 can include directly wired solutions, software-based solutions, or any combination thereof. The control circuitry 150 can be external to the shock application device 100 or internal to the shock application device 100, or a combination thereof. Control circuitry 150 can include wiring or systems that can be in communication with one or more components of the shock application device 100.

The robotic force application mechanism 101 can be coupled with, such as in communication with, the control circuitry 150. Components of the robotic force application mechanism 101 can be coupled with the control circuitry 150. The movement mechanism 120 can be coupled with the control circuitry 150 to receive instructions related to a force. The force can include a shock profile that can be tested, evaluated or studied. The shock profile can include at least a velocity or a duration at which the shock affecting component 110 can move towards a testing sample. The shock profile can include a mass component such as the mass of the shock application device 100, robotic force application mechanism 101, or the shock affecting component 110.

The shock affecting component 110 can be coupled with the control circuitry 150. The control circuitry 150 can provide instructions to the shock affecting component 110 to substantially, independently move according to the instructions. The control circuitry 150 can provide instructions to components of the robotic force application mechanism 101, such as the movement mechanism 120, to move components of the shock application device 100 according to a desired shock profile. The desired shock profile can include a simulation of a shock experienced during aerospace activities.

One or more actuators 114 can be electrically coupled with the control circuitry 150. The one or more actuators 114 can be coupled with the shock affecting component 110. The control circuitry 150 can provide instructions to the one or more actuators 114 related to movement of the shock affecting component 110. The one or more actuators 114 can convert energy, such as electrical or hydraulic, into a mechanical force that can move the shock affecting component 110. The mechanical force can movement at or approximately at a desired velocity, duration, direction, or the like of the shock affecting component 110. There can be one or more actuators 114 positioned throughout the robotic force application mechanism 101 to provide energy to the one or more joints 122 or other movement enabling components of the robotic force application mechanism 101.

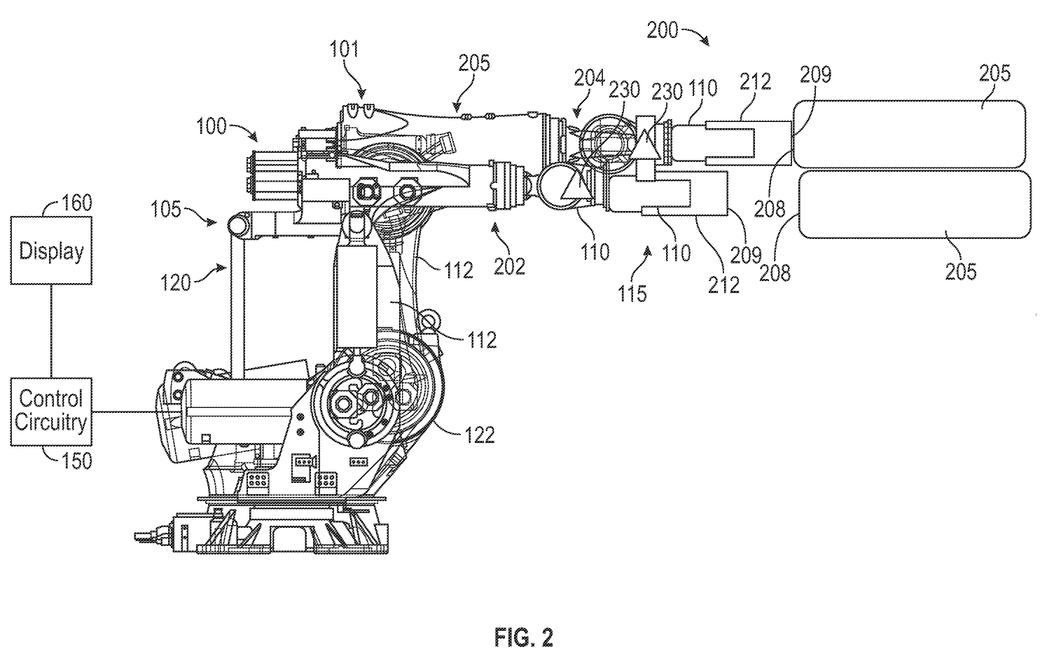

Illustrated in FIG. 2 is an example of the shock application device 100 as part of a shock testing system 200. The shock testing system 200 can include components that enable a user to test shock profiles up to approximately 10,000 Hertz. In other examples, the shock testing system 200 can include components that can test shock profiles greater than 10,000 Hertz, according to the desired arrangement. The shock testing system 200 can include components that enable a user to test shock profiles experienced during aerospace events or in aerospace environments.

The shock testing system 200 can includes the shock application device 100 positioned proximate to a testing unit 205 (e.g., a unit under test, sample, or the like). The testing unit 205 can be an actual structure that is designed to experience a shock, such as an aerospace device that can experience high-velocity activities, such as launching from the Earth, or launching from intermediary space vehicles. In another example, the testing unit 205 can be formed to simulate a structure that can experience a shock such as a desired shock profile. For example, the testing unit 205 can be formed to have a structure that can simulate an aerospace structure or a component of an aerospace structure. The testing unit 205 can be formed to have a structure that can simulate a structure that is exposed to high speed activities. The testing unit 205 can be formed to have a structure that can simulate a structure that is exposed to increases in pressure, or a constant high pressure. The testing unit 205 can be formed to simulate a structure that can be subject to shocks or forces during transportation.

The robotic force application mechanism 101 can be positioned away from and relative to the testing unit 205 with the shock affecting component 110 facing at least a portion of the testing unit 205. The shock affecting component 110 (e.g., unit under test, sample or the like) can be formed from an additive manufacturing (3-D printing) process. The shock affecting component 110 can be formed to simulate a shock, or shock-like forces. Utilizing additive manufacturing for the shock affecting component 110 can be relatively low-cost compared to other manufacturing methods. At times, the shock affecting component 110 can be produced on-site at a testing facility such that a new shock affecting component 110 can be manufactured at desired times. Additive manufacture can also allow the form of the shock affecting component 110 to include intricate internal details. Additive manufacturing can form a structure that can include detailed external forms.

The shock affecting component 110 can be formed to include crushable or fractural properties according to the force or shock to be simulated during testing. The unique design of the shock affecting component 110 can allow reasonably precise control over peak energy, duration of energy release, and frequencies transmitted. In some situations, including crushable or fractural properties in the shock affecting component 110 can be beneficial to understanding the effects of a longer force application because a substantially constant force can be applied to the shock affecting component 110 with minimal damping affect through the material. Through additive manufacturing, crush and fracture forms can be designed and manufactured for each test’s unique requirements.

Additive manufactured structures, such as the shock affecting component 110 can be formed to include properties that can simulate substantially consistent, extended-duration shock profiles. For example, the shock affecting component 110 can be formed to be excited with vibrations to achieve the desired testing. Then 1-time deformed test part can be replaced with another for the next shock application. The shock profiles can include plastic deformation properties and/or fracture energy properties rather than traditional elastic deformation methods. Elastic deformation methods can be used for short duration shock events (less than approximately 20 milliseconds). Elastic deformation can be used in short duration shock events because the material quickly returns to its original shape, preventing sustained force application. During elastic deformation, there is a ring-down affect what can result in a diminishing force level throughout the tested structure. The ring-down affect and limitations of an elastically deformable structure can present limitations in forming a shock affecting component 110 that can simulate a high g-force requirement as can be experienced during aerospace activities.

The arrangement of the shock testing system 200 can facilitate automated repositioning or movement of the robotic force application mechanism 101 or the shock affecting component 110 relative to the testing unit 205. The shock affecting component 110 can be a single use component. In one example, the shock affecting component 110 can be formed to apply a desired force causing vibration to be transferred to the testing unit 205.

In an example, the shock affecting component 110 can be reused. The shock affecting component 110 can apply a force along one location of the testing unit 205 (e.g., unit under test, sample, or the like). The robotic force application mechanism 101 can then reposition the shock affecting component 110 to apply a force along a second location of the testing unit 205. In an example, a “flail multi-impact” process can be implemented. During a flail multi-impact process, rotating elements, such as rotation robotic force application mechanism 101 or shock affecting component 110, can repetitively impact the testing unit 205 with glancing blows to extend shock time.

The shock affecting component 110 can include a damping mount 212 coupled with an external portion of the shock affecting component 110. Either at a proximal portion or distal portion of the shock affecting component 110, according to the design of the robotic force application mechanism 101. The damping mount 212 can be positioned along the robotic force application mechanism 101 as a protective component of the shock application device 100. The damping mount 212 can isolate proximal portions of the robotic force application mechanism 101 from the forces experienced by the shock affecting component 110. The damping mount 212 can be positioned along an external portion of the shock affecting component 110 such that the damping mount 212 can contact the testing unit 205. The damping mount 212 can include a force application surface 209 that can contact a testing unit face 208 of the testing unit 205.

FIG. 2 illustrates an example of the shock application device 100 in a first position 202 and a second position 204. Repositioning the robotic force application mechanism 101 can be controlled by the control circuitry 150 to move from a first position 202 to a second position 204, and positions therebetween. The control circuitry 150 can control movement of the robotic force application mechanism to move to, or through, positions beyond the first position 202 and the second position 204. In the second position 204 the robotic force application mechanism 101 can be repositioned or moved to a position closer to the testing unit 205 from the first position 202. In another example, the first and second positions can be reversed if retracting the robotic force application mechanism from a position proximate to the testing unit 205. In the second position 204, the robotic force application mechanism 101 can be repositioned to be proximate to the testing unit 205. In the second position 204, the robotic force application mechanism 101 can be moved to transfer a force to the testing unit 205. The robotic force application mechanism 101 can transfer a force through the shock affecting component 110 toward the testing unit 205. The testing unit 205 can receive a force from the shock affecting component 110. The shock affecting component 110 can move independently towards the testing unit 205 to transfer a force. The force that can be transferred can simulate a shock that can occur during aerospace activities, such as acceleration due to propulsion, gravitational impacts, or the like. The force can be similar to a shock experienced by a structure during transportation activities or the like.

The control circuitry 150 can supply instructions associated with the force that can be transferred to the testing unit 205 from the robotic force application mechanism 101. The control circuitry 150 can be programed to provide instructions to move the shock affecting component 110 to apply the force along at least one of three axes. The control circuitry 150 can be programs to communicate a force profile including a force including a direction, speed and stroke that simulates a desired shock profile experienced in a high gravitational force (high-g) environment.

The shock application device 100, including the robotic force application mechanism 101 and the shock affecting component 110, can move at a desired velocity toward the testing unit 205 and contact the testing unit 205 to simulate a shock experienced during high-speed activities. The velocity, or strike velocity, inertia and an impact force profile can be set by the design of the shock affecting component 110. The shock affecting component 110 can have a mass and stiffness profile designed for impacting the testing unit 205 according to the structure and desired shock. The shock affecting component 110 can have a desired form to apply the desired shock profile to the testing unit 205. The robotic force application mechanism 101 through the shock affecting component 110, can move at a velocity and force to apply a shock profile to the testing unit 205. The desired velocity and force can simulate an extended-duration shock profile. The extended duration can be greater than approximately 20 milliseconds. The extended duration shock-profile can result in one or more of plastic deformation and fracture energy of the shock affecting component 110. The shock profile can be applied to the testing unit 205 by the shock affecting component 110 to understand the shock experienced by the testing unit 205 as the structure. Utilizing the shock application device 100 via the robotic force application mechanism 101 and the shock affecting component 110 an extended-duration force can be applied to the testing unit 205 that can be difficult to achieve using, for example, a ball-drop testing mechanism or the like.

Positioned at one or more locations of the shock testing system 200 can be one or more sensors 230. The one or more sensors 230 can be coupled to at least one of the shock application device 100, the robotic force application mechanism 101 and the shock affecting component 110. The one or more sensors 230 can be in communication with the control circuitry 150. The one or more sensors 230 can measure or detect data corresponding to the movement of at least one of the robotic force application mechanism 101 and the shock affecting component 110. The one or more sensors 230 can measure or detect data corresponding to the reaction of the testing unit 205. For example, the one or more sensors 230 can measure or detect a change in the testing unit 205 when impacted by the shock affecting component 110.

Optionally, one or more sensors 230 can be positioned proximate to the testing unit 205. The one or more sensors 230 coupled with at least a portion of the shock application device 100 can be in communication with another at least one of the one or more sensors 230 proximate to the shock affecting component 110. Information, data, or the like can be detected or measured by the one or more sensors 230 related to the interaction between the shock affecting component 110 and the testing unit 205.

The one or more sensors 230 can output data (e.g., measurements, detections, or the like) to a display 160. The display 160 can include a communication system including a screen, speaker, or other sensory outputting system. The control circuitry 150 can communicate the output data from components of the shock application device 100 to the display 160. The display 160 can communicate the output data received from the shock application device 100 to a user. The display 160 can communicate data received from the one or more sensors 230 to the user.

The control circuitry 150 can receive data from the one or more sensors 230 and process or analyze the data. The control circuitry 150 can communicate the processed or analyzed data to the display 160.

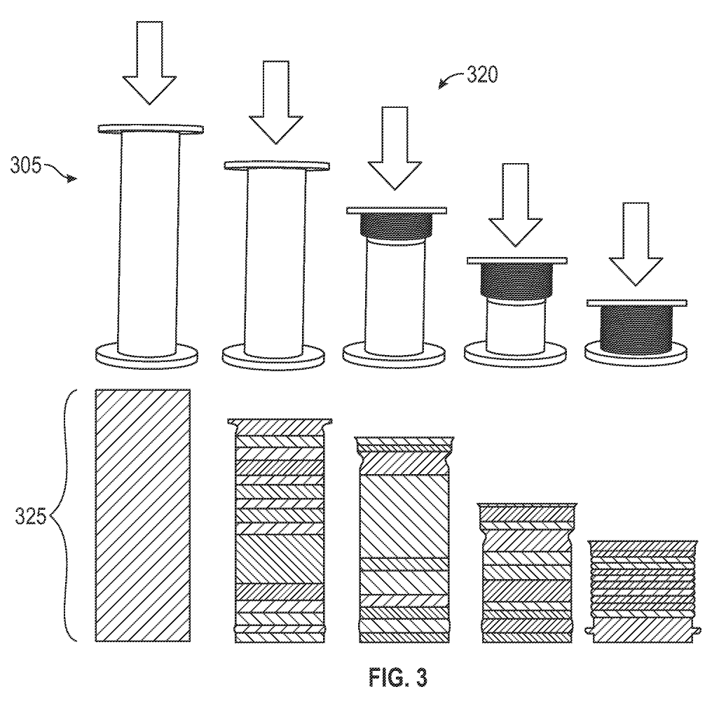

Illustrated in FIG. 3, is an example of a crush profile applied to the shock affecting component 305 via the shock application device 100. The at least one of the robotic force application mechanism 101 or the shock affecting component 110 can cause plastic deformation or a crush event of the shock affecting component 110, as illustrated and discussed related to FIGS. 1 and 2. During a plastic deformation or crush deformation event, a constant force 320 can be applied throughout the testing procedure that can simulate a high g-force event. During plastic deformation, crushing can allow for longer duration shock profiles compared to traditional elastic deformation methods, as the material gradually compresses. The local stress in the shock affecting component 305 can be an indication of where it is beginning to buckle during a crush sequence. The crush sequence illustrated in FIG. 3 can be modeled to simulate crushing. After crushing, the shock affecting unit can be stable, usually pressing against other supporting bent material, and the next weakest area then sees high stress and buckles. This can be repeatable for a structure.

The use of the robotic force application mechanism 101 and the shock affecting component 110, as illustrated and discussed related to FIGS. 1 and 2, can assist in applying, maintaining or sustaining consistent force application throughout the crushing, or plastic deformation, process. Plastic deformation can provide a more consistent force 320 application transferred by the shock affecting component 110 throughout substantially the entire duration of the shock event. To achieve a crushing deformation, at least one of the robotic force application mechanism 101 or the shock affecting component 110 can impart lower frequency forces toward the shock affecting component 305. To achieve fracturing deformation, the robotic force application mechanism 101 or the shock affecting component 110 can provide higher frequency forces, such as up to 10,000 Hertz, or other frequencies, which can be beneficial for understanding or testing structures used in aerospace applications.

The constant force 320 (including fracturing force) can be tailored to impart a desired amount of force and energy with a velocity. As illustrated by the gradient 325, the constant force 320 applied to the shock affecting component 305 can be substantially consistent. The use of at least one of the robotic force application mechanism 101 and the shock affecting component 110 can impart a consistent energy for a longer duration that can be difficult to achieve with a traditional ball-drop method.

Utilizing at least one of the robotic force application mechanism 101 and the shock affecting component 110 can allow for shock testing along one or more angles relative to the testing unit 205 that can be difficult to achieve with a traditional ball-drop testing mechanism. The robotic force application mechanism 101 and the shock affecting component 110 can be angled according to the shock testing application desired. For example, in some applications a structure can experience a shock at an angle that is not a directly toward the testing unit face 208 (as illustrated in FIG. 2). The shock affecting component 110 can apply a force to a desired portion of the force application surface 209, as dictated by the testing procedures.

In some examples, the control circuitry 150 can provide instructions to the robotic force application mechanism 101 to apply a force at a first direction then subsequently provide instructions to apply a force at a second, different direction. The control circuitry can provide instructions to change direction without changing the testing setup or any equipment. The application of force can be applied sequentially at different directions along one or more axes, such as x, y, and z.

The control circuitry 150 can implement a model-based systems engineering (MBSE) approach to fracture prediction analysis. MBSE includes modeling or simulations based on inputs to support system requirements, design, analysis, verification, and validation activities throughout the testing procedures. For example, the control circuitry 150 can implement the MBSE approach to designing testing procedures for shock testing. For example, the control circuitry 150 can include testing procedures that were generated form the MBSE approach for durations beyond approximately 20 milliseconds. Instructing the robotic force application mechanism 101 or the shock affecting component 110 to apply a force for longer than approximately 20 milliseconds can simulate shock during applications where there can be high g-force, such as g-force levels experienced during space and defense applications. This MBSE methodology can overcome some of the limitations of conventional shock testing methods by utilizing crush forms that can be modeled to require a specified force for a specified duration. This methodology can then be programmed distinctly for each test through additive manufacturing to impart a consistent force application across a duration not possible with traditional single-strike method.

The MBSE capabilities can allow for predictions of how materials will behave during plastic deformation and fracture. The shock affecting component 110, 305 (as discussed related to FIGS. 2 and 3) can be formed according to the modeling capabilities to prepare the shock affecting component to include crush forms that can be modeled according to force and duration specifications. For example, the shock affecting component 110, 305 can be formed of materials that can simulate a shock that can be experienced by an aerospace structure and include desired crush forms for testing procedures to be affective. The testing unit 205 can be formed of a specified material presenting a stiffness and geometry that is suitable for the applied force from the shock affecting component 110. Additive manufacturing can include a combination of materials or reinforcements that can more accurately produce the modeled shapes and material performance according to the force applied. In some examples, MBSE can support an artificial intelligence (AI) generated testing until profile and properties.

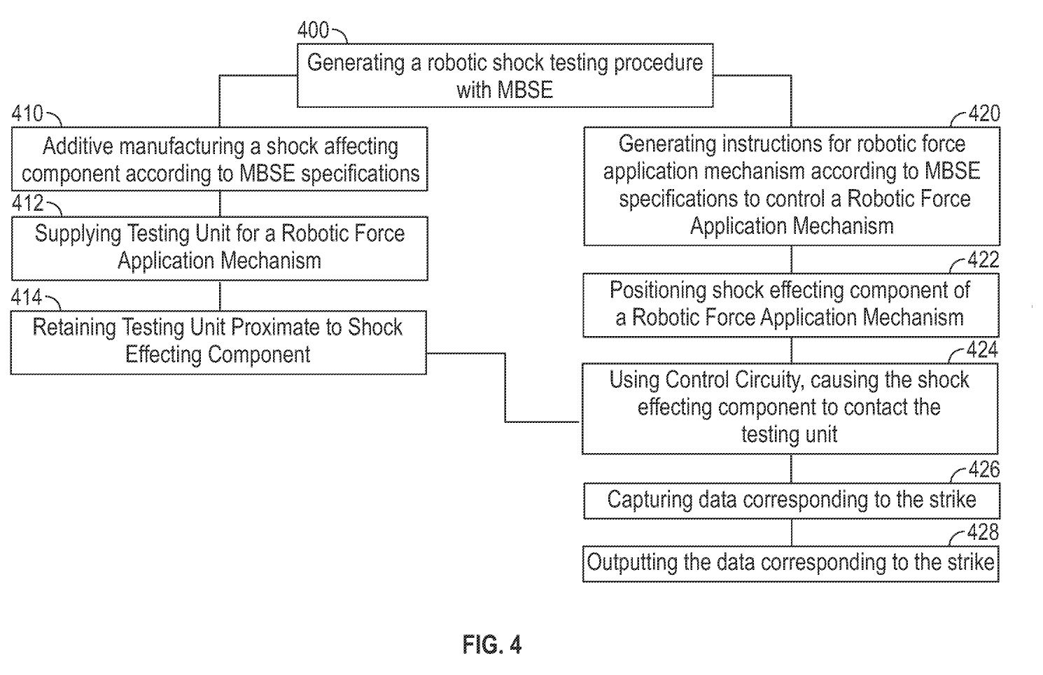

Illustrated in FIG. 4 is an example of a method for robotic shock testing. As in step 400, the method for robotic shock testing can include generating a robotic shock testing procedure with model based system engineering (MBSE), as discussed related to FIG. 3. The method can include forming a shock affecting component and a robotic force application mechanism that, when used together, can simulate a force and a resulting effect on a structure, or testing unit, such as an aerospace structure. The force applied can translate into a plastic deformation or fracture deformation of the shock affecting component. The force applied can be a constant force throughout application.

As in step 410, a shock testing procedure can be generated with Model-Based Systems Engineering (MBSE) to determine specifications for the shock affecting component and robotic force application mechanism.

As in step 412, a shock affecting component can be manufacture according to the MBSE specifications using additive manufacturing techniques. The shock affecting component can be formed to include crushable or fracturing media tailored for peak energy, duration of energy release, and frequencies transmitted. The shock affecting component can be formed to simulate a force or shock that can be applied to a testing unit (e.g., unit under test) such as an aerospace structure. As in step 414, the testing unit can be supplied in a position relative to the robotic force application mechanism.

As in step 420, generating instructions for the robotic force application mechanism according to MBSE specifications to control movement, velocity, and force application. The instructions generated can include an impact force profile. The impact force profile includes a force application component. The impact force profile can also include maintaining a velocity throughout the transferring of a force associated with the impact force profile. The impact force profile can simulate a force experienced during an aerospace activity.

As in step 422, positioning the shock affecting component of the robotic force application mechanism proximate to the testing unit. The generated instructions can include transferring the impact force profile to the force application system. Transferring the impact force profile can include generating a force application instruction to control the force application system. The force application instructions can be communicated, or sent, to control the force application system. The instructions can cause the shock affecting component to engage (e.g., contact, momentarily contact, touch, or the like) with the testing unit. The force application instructions can include providing directions to the shock affecting component for the force application face to engage (e.g., contact, momentarily contact, touch, or the like) with a structure (e.g., unit under test, testing unit, sample or the like) and apply, for example, a force to the structure, as the testing unit. In an example, the force application face of the shock affecting component 110 can briefly (e.g., less than a second, less than 50 milliseconds, less than 20 milliseconds or the like) engage with the structure, as a unit under test or a testing sample, to apply a force to the structure.

As in step 424, control circuitry can be implemented to cause the shock affecting component to be repositioned and move. The control circuitry can cause the shock affecting component to move to contact the testing unit with a consistent force application across a desired duration. The control circuitry can cause the shock affecting component to cause at least one of a plastic deformation or fracture deformation of the testing unit.

As in step 426, data can be captured corresponding to the engagement with the testing unit using at least one sensor.

As in step 428, the data can be output to the control circuitry. The data can correspond to the engagement for analysis of the shock testing results.

The data captured or output and analyzed can be evaluated. The evaluated data can notify a user to adjust the impact force profile according to a quality of the shock affecting component after a first transfer of the impact force profile. The evaluated data can automatically adjust the impact force profile according to a quality of the shock affecting component after a first transfer of the impact force profile.

Optionally, the steps in the method described can be repeated. For example, the impact force profile can be repetitively transferred to the testing unit. The method enables the shock affecting component to undergo plastic deformation when engaged with the testing unit, maintaining a substantially constant force throughout the shock duration.

### Aspects

Aspect 1 can include subject matter such as a shock testing system comprising: a robotic force application mechanism including a shock affecting component positioned along a distal portion of the robotic force application mechanism; a testing unit retained proximate to the shock affecting component; wherein the shock affecting component is configured to transfer a force to the testing unit; a control circuitry in communication with the shock affecting component, the control circuitry configured to supply instructions associated with the force to be transferred to the testing unit to the robotic force application mechanism; and the shock affecting component configured to experience deformation upon transference of the force to the testing unit.

Aspect 2 can include, or can optionally be combined with the subject matter of Aspect 1, to optionally include the control circuitry is in communication with the shock affecting component; wherein the control circuitry configured to provide instructions to move the shock affecting component to apply the force along at least one of three axes.

Aspect 3 can include, or can optionally be combined with the subject matter of one or any combination of Aspects 1 or 2 to optionally include the shock affecting component is configured to apply the force with a direction, speed and stroke that simulates a desired shock profile experienced in a high-g environment.

Aspect 4 can include, or can optionally be combined with the subject matter of one or any combination of Aspects 1 to 3 to optionally include the shock affecting component is configured to apply a fracturing force.

Aspect 5 can include, or can optionally be combined with the subject matter of one or any combination of Aspects 1 to 4 to optionally include one or more shock affecting components each coupled with the distal portion of the robotic force application mechanism.

Aspect 6 can include, or can optionally be combined with the subject matter of one or any combination of Aspects 1 to 5 to optionally include a damping mount coupled with the robotic force application mechanism proximate to the shock affecting component.

Aspect 7 can include, or can optionally be combined with the subject matter of one or any combination of Aspects 1 to 6 to optionally include the shock affecting component is formed from an additive manufacturing process; wherein the testing unit is formed to simulate an aerospace structure.

Aspect 8 can include, or can optionally be combined with the subject matter of one or any combination of Aspects 1 to 7 to optionally include the shock affecting component includes plastic properties according to a desired shock profile.

Aspect 9 can include subject matter such as method of applying a shock to a testing structure comprising: providing a robotic force application mechanism including: a force application system; and a shock affecting component coupled at a distal portion of the force application system; supplying a testing unit; retaining the testing unit proximate to the shock affecting component; activating the shock affecting component to move toward the testing unit; and transferring an impact force profile, including a force application, from the shock affecting component along at least one of three axes to the testing unit including: generating, using processing circuitry, a force application instruction to control the force application system; sending the force application instruction to control circuitry to the force application system; using the control circuitry to cause the shock affecting component to engage with the testing unit; and capturing, using at least one sensor, data corresponding to the engagement with the testing unit; and causing the shock affecting component to undergo plastic deformation when the shock affecting component engages with the testing unit.

Aspect 10 can include, or can optionally be combined with the subject matter of Aspect 9, to optionally include the impact force profile includes maintaining a velocity throughout the transferring of a force associated with the impact force profile.

Aspect 11 can include, or can optionally be combined with the subject matter of Aspect 10 or 12, to optionally include repeating transferring the impact force profile to the testing unit.

Aspect 12 can include, or can optionally be combined with the subject matter of one or any combination of Aspects 10 or 11 to optionally include simulating a shock experienced by an aerospace structure including: forming the testing unit including structural properties similar to the aerospace structure; and moving the shock affecting component at a desired velocity for a desired time duration toward the testing unit.

Aspect 13 can include, or can optionally be combined with the subject matter of one or any combination of Aspects 9 to 12 to optionally include the shock affecting component is configured to transmit a consistent force causing plastic deformation of the shock affecting component.

Aspect 14 can include, or can optionally be combined with the subject matter of one or any combination of Aspects 9 to 13 to optionally include transmitting a force to the testing unit formed to simulate an aerospace structure, to cause at least one of a plastic deformation or fracture deformation of the testing unit.

Aspect 15 can include, or can optionally be combined with the subject matter of one or any combination of Aspects 9 to 14 to optionally include adjusting the impact force profile according to the shock affecting component after a first transfer of the impact force profile.

Aspect 16 can include, or can optionally be combined with the subject matter of one or any combination of Aspects 9 to 15 to optionally include the impact force profile simulates a force experienced during an aerospace activity.

Aspect 17 can include subject matter such as shock application device comprising: a robotic force application mechanism configured to simulate a shock experienced during a high gravitational force activity including: a force application system; a shock affecting component coupled to a distal portion of the force application system; a movement mechanism configured to reposition at least one of the force application system or the shock affecting component; wherein the shock affecting component is configured to be repositioned according to a desired velocity and for a desired duration; and a control circuitry in communication with at least one of the force application system, shock affecting component or the movement mechanism; wherein the control circuitry is configured to communicate the velocity according to a desired shock profile to at least one of force application system, the shock affecting component and the movement mechanism.

Aspect 18 can include, or can optionally be combined with the subject matter of Aspect 17, to optionally include the movement mechanism is coupled to a proximal portion of the force application system and the shock affecting component; wherein the shock affecting component is configured to move along at least one of three axes.

Aspect 19 can include, or can optionally be combined with the subject matter of one or any combination of Aspects 17 to 18 to optionally include the control circuitry is configured to communicate the desired velocity for the desired duration according to the desired shock profile; wherein the desired shock profile is generated by model-based systems engineering.

Aspect 20 can include, or can optionally be combined with the subject matter of one or any combination of Aspects 17 to 19 to optionally include the control circuitry is configured to communicate a shock profile that simulates shock experienced during aerospace activities.

The above description includes references to the accompanying drawings, which form a part of the detailed description. The drawings show, by way of illustration, specific embodiments in which the disclosed concepts can be practiced. These embodiments are also referred to herein as “aspects” or “examples.” Such aspects or example can include elements in addition to those shown or described. However, the description also contemplates aspects or examples in which only those elements shown or described are provided. Moreover, the description also contemplates aspects or examples using any combination or permutation of those elements shown or described (or one or more features thereof), either with respect to a particular aspects or examples (or one or more features thereof), or with respect to other Aspects (or one or more features thereof) shown or described herein.

In the event of inconsistent usages between this document and any documents so incorporated by reference, the usage in this document controls.

In this document, the terms “a” or “an” are used, as can be common in patent documents, to include one or more than one, independent of any other instances or usages of “at least one” or “one or more.” In this document, the term “or” can be used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel,” “perpendicular,” “round,” or “square,” are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that can be slightly oblong or can be a many-sided polygon) is still encompassed by this description.

The above description is intended to be illustrative, and not restrictive. For example, the above-described aspects or examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, subject matter may lie in less than all features of a particular disclosed embodiment. Thus, the following claims are hereby incorporated into the Detailed Description as aspects, examples, or embodiments, with each claim standing on its own as a separate embodiment, and it can be contemplated that such embodiments can be combined with each other in various combinations or permutations. The scope of the disclosed concepts should be determined with reference to the appended claims, along with the full scope of equivalents to which such claims are entitled.

1. A shock testing system comprising:
a robotic force application mechanism including a shock affecting component positioned along a distal portion of the robotic force application mechanism;
a testing unit retained proximate to the shock affecting component;
wherein the shock affecting component is configured to transfer a force to the testing unit;
a control circuitry in communication with the shock affecting component, the control circuitry configured to supply instructions associated with the force to be transferred to the testing unit to the robotic force application mechanism; and
the shock affecting component configured to experience deformation upon transference of the force to the testing unit.

2. The shock testing system of claim 1, wherein the control circuitry configured to provide instructions to move the shock affecting component to apply the force along at least one of three axes.

3. The shock testing system of claim 1, wherein the shock affecting component is configured to apply the force with a direction, speed and stroke that simulates a desired shock profile experienced in a high-g environment.

4. The shock testing system of claim 1, wherein the shock affecting component is configured to apply a fracturing force.

5. The shock testing system of claim 1, including one or more shock affecting components each coupled with the distal portion of the robotic force application mechanism.

6. The shock testing system of claim 1, including a damping mount coupled with the robotic force application mechanism proximate to the shock affecting component.

7. The shock testing system of claim 1, wherein the shock affecting component is formed from an additive manufacturing process;
wherein the testing unit is formed to simulate an aerospace structure.

8. The shock testing system of claim 1, wherein the shock affecting component includes plastic properties according to a desired shock profile.

9. A method of applying a shock to a testing structure comprising:
providing a robotic force application mechanism including:
a force application system; and
a shock affecting component coupled at a distal portion of the force application system;
supplying a testing unit;
retaining the testing unit proximate to the shock affecting component;
activating the shock affecting component to move toward the testing unit; and
transferring an impact force profile, including a force application, from the shock affecting component along at least one of three axes to the testing unit including:
generating, using processing circuitry, a force application instruction to control the force application system;
sending the force application instruction to control circuitry to the force application system;
using the control circuitry to cause the shock affecting component to engage with the testing unit; and
capturing, using at least one sensor, data corresponding to the engagement with the testing unit; and
causing the shock affecting component to undergo plastic deformation when the shock affecting component engages with the testing unit.

10. The method of applying the shock to the testing structure of claim 9, wherein the impact force profile includes maintaining a velocity throughout the transferring of a force associated with the impact force profile.

11. The method of applying the shock to the testing structure of claim 9, including repeating transferring the impact force profile to the testing unit.

12. The method of applying the shock to the testing structure of claim 9, including simulating a shock experienced by an aerospace structure including:
forming the testing unit including structural properties similar to the aerospace structure; and
moving the shock affecting component at a desired velocity for a desired time duration toward the testing unit.

13. The method of applying the shock to the testing structure of claim 9, wherein the shock affecting component is configured to transmit a consistent force causing plastic deformation of the shock affecting component.

14. The method of applying the shock to the testing structure of claim 9, including transmitting a force to the testing unit formed to simulate an aerospace structure, to cause at least one of a plastic deformation or fracture deformation of the testing unit.

15. The method of applying the shock to the testing structure of claim 9, including:
adjusting the impact force profile according to the shock affecting component after a first transfer of the impact force profile.

16. The method of applying the shock to the testing structure of claim 9, wherein the impact force profile simulates a force experienced during an aerospace activity.

17. A shock application device comprising:
a robotic force application mechanism configured to simulate a shock experienced during a high gravitational force activity including:
a force application system;
a shock affecting component coupled to a distal portion of the force application system;
a movement mechanism configured to reposition at least one of the force application system or the shock affecting component;
wherein the shock affecting component is configured to be repositioned according to a desired velocity and for a desired duration; and
a control circuitry in communication with at least one of the force application system, shock affecting component or the movement mechanism;
wherein the control circuitry is configured to communicate the velocity according to a desired shock profile to at least one of force application system, the shock affecting component, and the movement mechanism.

18. The shock application device of claim 17, wherein the movement mechanism is coupled to a proximal portion of the force application system and the shock affecting component;
wherein the shock affecting component is configured to move along at least one of three axes.

19. The shock application device of claim 17, wherein the control circuitry is configured to communicate the desired velocity for the desired duration according to the desired shock profile;
wherein the desired shock profile is generated by model-based systems engineering.

20. The shock application device of claim 17, wherein the control circuitry is configured to communicate a shock profile that simulates shock experienced during aerospace activities.
